(19) United States
(12) Patent Application Publication
(10) Pub. No.: US 2017/0364640 A1
(43) Pub. Date: Dec. 21, 2017

(54) MACHINE LEARNING ALGORITHM TO AUTOMATE HEALTHCARE COMMUNICATIONS USING NLG

(71) Applicant: KONINKLIJKE PHILIPS N.V., EINDHOVEN (NL)

(72) Inventor: Omar BADAWI, Lutherville Timonium, MD (US)

(21) Appl. No.: 15/620,867

(22) Filed: Jun. 13, 2017

Related U.S. Application Data
(60) Provisional application No. 62/350,851, filed on Jun. 16, 2016.

(51) Int. Cl. G06F 19/00; G06N 99/00; G06Q 50/24; G06Q 10/10

(52) U.S. Cl. CPC G06F 19/324; G06Q 50/24; G06F 19/345; G06N 99/005; G06Q 10/10

(57) ABSTRACT

A method for automated analysis of medical records which executes a medical analysis algorithm to analyze patient data to generate an electronic narrative document. The electronic narrative document is stored in a patient database, which may be retrieved for viewing and editing by a user. As changes are made by the user, the medical analysis algorithm will predict and make suggestions in real-time. If the user selects to manually modify the electronic narrative document, the changes are stored for subsequent use.

### CROSS-REFERENCE TO PRIOR APPLICATIONS

This application claims benefit of U.S. Provisional Patent Application No. 62/350,851, filed on 16 Jun. 2016. These applications are hereby incorporated by reference herein.

### BACKGROUND OF THE INVENTION

Physicians spend a significant amount of time manually writing or dictating clinical notes regarding diagnoses, laboratory results, examination notes, and prescribed treatments. Many physicians, nurses, and caregivers manually cut and paste notes from other charts to streamline the process. Carelessness and demanding workloads can lead to errors that may lead to potentially incoherent, incompatible, and even inapplicable notes.

To improve the efficiency of medical note writing, solutions have been proposed which would automate the document generation process. Typically, these automated document generation systems incorporate algorithms that analyze a patient's medical record and generate a narrative text. For instance, U.S. Patent Application No. 2013/0304507 describes clinical note generator which enables creation, storage, and editing of a narrative based on patient measures. One problem with such a system is that in the event that the notes of the narrative text are inconsistent with the intent of the writer, much of the auto-generated text would have to be deleted and rewritten. So despite the promise of natural language processing, such systems, in practice, often leave the writer with the same problem they are faced with when not using a natural language generator and end up having to rewrite much of the text. Accordingly, what is needed is a system and method which overcomes one or more of the deficiencies in the art.

### BRIEF SUMMARY OF THE INVENTION

The present invention relates to a system having a server for executing an analysis algorithm for generating an electronic narrative document and a user device for modifying the generated electronic narrative document to suggest text based on user input.

The present invention also relates to a method for automated analysis of medical records. The method of the present invention comprises executing an analysis algorithm to analyze the medical records and to generate an electronic narrative document. After generating an electronic narrative document, it is stored in the patient database. The stored electronic narrative document is then retrieved and viewed by a user. This document is to be modified by the user, wherein the analysis algorithm predicts and suggests input during the modification step based on the patient's medical records. The electronic narrative document is then updated in the patient database.

### BRIEF DESCRIPTION OF THE DRAWINGS

The accompanying drawings, which are included to provide a further understanding of the invention, are incorporated herein to illustrate embodiments of the invention. Along with the description, they also serve to explain the principle of the invention. In the drawings:

FIG. 1 illustrates a system for analyzing patient medical record according to the preferred embodiment of the present invention.

FIG. 2 illustrates a flowchart for analyzing patient medical record according to the preferred embodiment of the present invention.

FIG. 3 illustrates an electronic document showing the initial diagnosis generated by the medical analysis algorithm.

FIG. 4 illustrates an alternative electronic document showing the medication suggestions based on the initial diagnosis.

FIG. 5 illustrates an alternative electronic document showing the suggested corrections in spelling.

### DETAILED DESCRIPTION OF THE VARIOUS EMBODIMENTS OF THE INVENTION

The following are definitions of terms as used in the various embodiments of the present invention.

The term “natural language” refers to some type of language that approximates or is more or less recognizable as human-based language.

The term “Natural Language Generation” or “NLG” as used herein refers to a system or process for automatically generating narrative texts from computer accessible data.

The term “patient medical record” as used herein refers to a print or electronic document that includes information or data relating to a patient's age, weight, symptoms, diagnosis, laboratory tests, vital signs, prescribed medications, care plan, discharge instructions and other relevant information or data relating to the patient.

The term “database” as used herein refers to a collection of data and information or data organized in such a way as to allow the data and information or data to be stored, retrieved, updated, and manipulated and to allow them to be presented into one or more formats such as in table form or to be grouped into text, numbers, images, and audio data. The term “database” as used herein may also refer to a portion of a larger database, which in this case forms a type of database within a database. “Database” as used herein also refers to conventional databases that may reside locally or that may be accessed from a remote location, e.g., remote network servers. The database typically resides in computer memory that includes various types of volatile and nonvolatile computer memory. Memory wherein the database resides may include high-speed random access memory or non-volatile memory such as magnetic disk storage devices, optical storage devices, and flash memory. Memory where the database resides may also comprise one or more software for processing and organizing data received by and stored into the database.

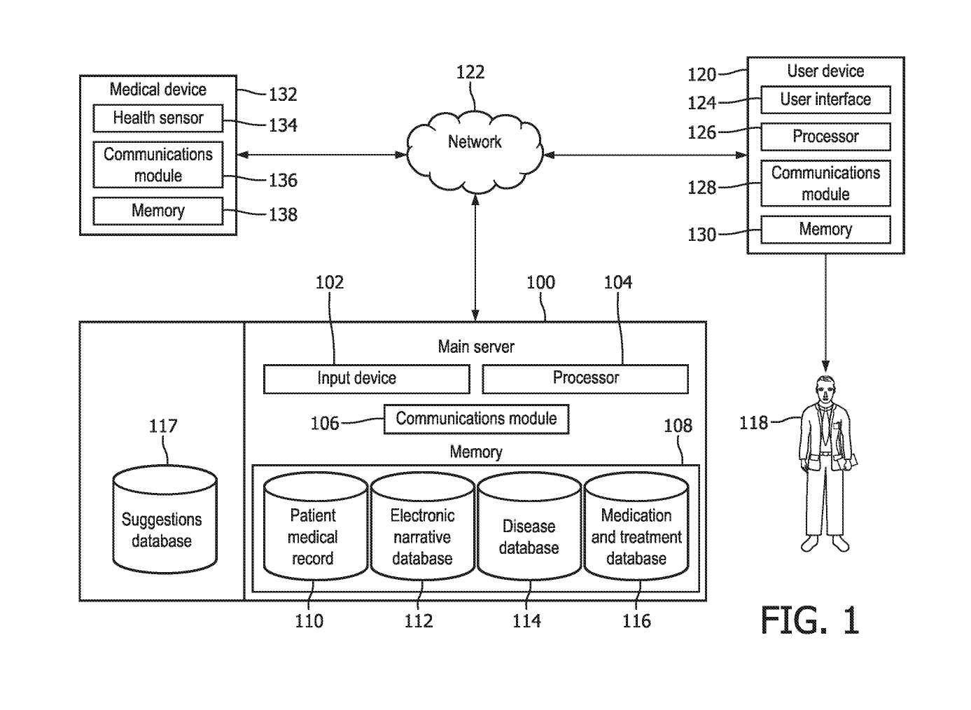

FIG. 1 illustrates a system for analyzing patient medical records according to the preferred embodiment of the present invention. The main server 100 comprises an input device 102, processor 104, communications module 106, and a memory 108. The memory 108 further comprises patient medical record 110, electronic narrative database 112, disease database 114, medication and treatment plan database 116, and a suggestion database 117. While these databases are depicted as being located in the memory 108 of the main server 100, it is also contemplated that the databases may be remotely located and connected to the main server via the network 122.

The patient medical record 110 includes data relating to the attending physician's initial diagnosis, laboratory tests, vital signs, prescribed medications, care plan, biometrics, and other relevant information relating to the patient's medical history. Information relating to diseases and corresponding symptoms are stored in the disease database 114. This database may classify the diseases such as by ICD-10 or via other similar classification system. The medication and treatment plan database 116 includes recommended treatment, such as prescribed medicines, dietary instructions, bed rest instructions, and prescribed physical activities. The medication and treatment plan database 116 may also include dietary and activity restrictions or instructions deemed to be therapeutic and/or supportive The narrative text database 112 includes both complete documents associated with patients as well as a suggestions which may be searchable by algorithm 200. And, the suggestions database 117 includes suggestions to be provided to the user 218 in real-time while editing the narrative text document. These suggestions may be complete words which are suggested as characters are typed by the user. Or, the suggestions, may correct spellings to detected mistyped words. Or, the suggestions may be common phrases when the user has typed the first few words of the phrase. Or, the suggestions may be synonyms of words or alternative drug names, diseases, etc.

The main server 100 is accessed by a user device 120 via a network. The user device 120 comprises a user interface 124, a processor 126, communications module 128, and a memory 130. The user device 120 may be a desktop, a laptop, a tablet, a smartphone, or any other devices that comprise at least one or more processors, one or more types of memory, and at least one computer program or operating system. The user interface 124 may be a touchscreen display, voice prompt, or keypad, including buttons and/or a gesture-driven interface. The medical device 132 used for acquiring a patient's health-related information may comprise a health sensor 134 (including but not limited to blood pressure, weight, activity, respiration, pulse/oximetry and other similar sensors well-known in the art), communications module 136 (including but not limited to wireless communications such as WiFi, Bluetooth, or Zigbee and wired communications such as Ethernet), and memory 138. The main server 100 is accessible to any authorized personnel 118 including physicians, nurses, caregivers, case managers, or administrators.

The patient's health-related information is acquired via at least one of the following methods: audio recognition, manual input, and direct measurement of health data using a medical device. The data may come from a variety of sources such as the patient's electronic medical records, insurance providers, sensors and the like. Preferably, the device 120 used by the user 118 is a computing device that can be used for inputting or acquiring the patient's health-related information, such as a tablet, smartphone, and desktop computer, among others. The acquired data may be initially stored in the one or more device's memory and later transmitted via wireless or wired connections to the hospital main server 100.

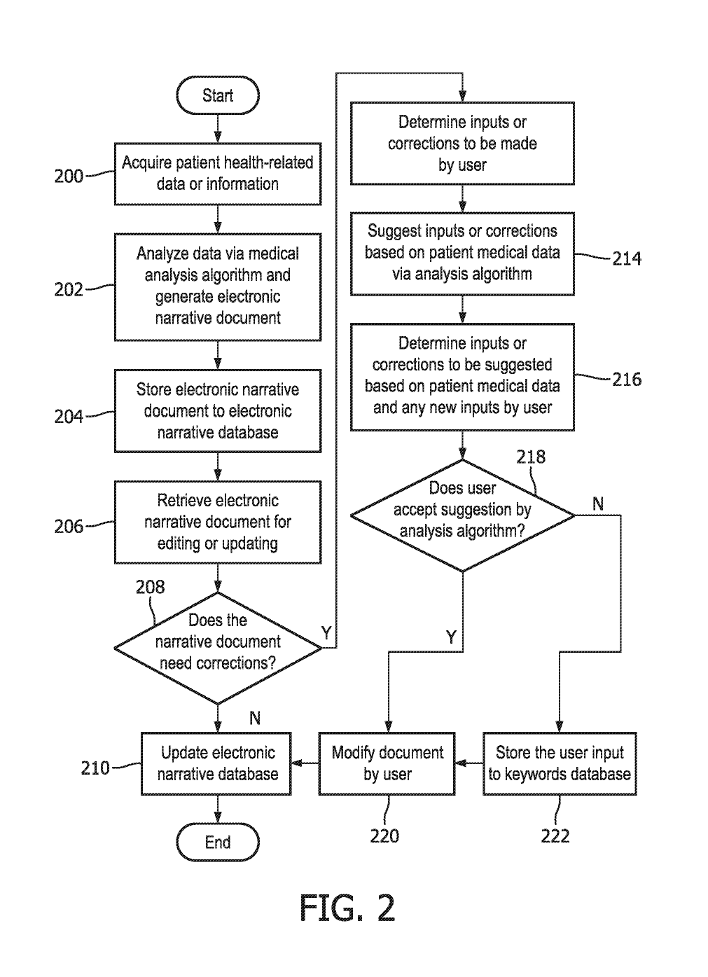

FIG. 2 is a flowchart that illustrates a process involving the storing and editing of the electronic narrative document. A patient's health-related information or data is acquired using one or more devices 122 (step 200). The acquired information may be initially stored in the device's memory 132 and later transmitted 130 to the hospital network server 100. Using an analysis algorithm, an electronic narrative document about the patient is generated based on the patient's health-related information (step 202). The narrative document could be a variety of different documents commonly drafted by users such as but not limited to a note to the patient's medical record, a diagnosis, a care plan, or discharge instructions. The analysis algorithm may use a variety of techniques for generating the narrative document. For instance, the narrative document may be created by simply selecting a similar document from another patient in the database who is most closely related to the current patient based on one or more criteria such as disease, medication, treatment, or medical records. Or, the narrative document could be generated based on, in the case of a diagnosis, the disease database could be queried for the disease diagnosed and pre-drafted text could be selected which describes the disease or provides other relevant medical information. Or, in the case of providing instructions on the use of medication, a pre-drafted medication description and dosing regimen could be selected. Or, in the case of a treatment plan, a pre-drafted care plan could be generated, which is based on a determined best practice.

Alternatively, in another embodiment, Natural language generation (NLG) or Natural language processing (NLP) may be used to generate the narrative document. As known to those skilled in the art, NLG/NLP is a machine processing task that converts pieces of data or information into human-readable format. Data or information undergoes levels of organization before it can be rendered by the machine into a narrative that resembles natural language. The hospital main server 100 is preferably integrated with NLG in a software, in which the medical analysis algorithm identifies data or information about the patient, such as name, age, address, gender, patient room assignments, patient medical history, diagnosis, treatment plans, prescribed medication, known allergies, family history, and other relevant information or data relating to the patient. The identified data or information is then organized using one or more data structures or template. Then, the medical analysis algorithm constructs sentences using the acquired or retrieved patient-related data or information while following the medical analysis algorithm's pre-defined grammar, syntax, and morphology rules. If the medical analysis algorithm generates ideas or sentences that are similar or related, the algorithm tries to combine them into a single sentence. When describing events or the severity of a patient's medical condition, the algorithm chooses appropriate words, for example, choosing mild or severe when describing the patient's cough. The machine then incorporates expressions of referral to improve the context of the sentences. Using syntax and language conventions, the sense of the narrative is completed by combining the different ideas and sentences into an actual text. One of ordinary skill in the art can appreciate that a variety of technics can be used to generate the electronic narrative document without departing from the scope of this invention.

In a preferred embodiment of the present invention, the generation of the electronic narrative document is automated once the patient-related information or data is received by the one or more devices connected wirelessly to the hospital main server 100. Alternatively, the generation of the electronic narrative document can initially be stored in the one or more devices' memory, then preferably later require a prompt from a medical personnel 118. The electronic narrative document comprise at least one of the patient's vital status upon admission, symptoms related to patient's medical condition, sequence of events that describe the development of symptoms, prior medications or admissions, and medical notes recommending further actions for and by the patient.

Once generated, the electronic narrative document is stored in the electronic narrative database 112 (step 204) associated with the patient. A user 118 then retrieves the stored electronic narrative document using a user device 120 (step 206) and checks for errors (step 208). If the retrieved electronic narrative document requires no corrections, the user may approve the narrative text which is then stored in the hospital main server 100 (step 210).

If the retrieved electronic narrative document requires corrections, the user can determine the corrections to be made (step 212). Once the corrections are identified, the user 118 selects or edits the elements to be edited. While the user 118 makes corrections, the analysis algorithm searches the narrative text database and presents suggestions for corrections in real-time (step 214). This may be done via a variety of techniques. One such technique would be for the algorithm to identify the characters typed (which may be complete words, partial-words, phrases or even misspellings). It may suggest a complete word based on the characters typed. It may suggest synonyms based on the characters typed which are deemed to be likely, or often selected, alternatives. It may suggest conceptually similar phrases.

Next, the user 118 determines the inputs or corrections to be made (step 216) and compares them with the suggestions provided by the analysis algorithm (step 218). If the user 118 agrees with the one or more suggestions provided by the analysis algorithm, the user 118 selects the matching one or more suggestions which is incorporated into the narrative document and then saves the revised patient electronic narrative document (step 220). If the user 118 does not agree with the one or more suggestions provided by the medical analysis algorithm, the new inputs or corrections made by the user 118 are incorporated in the electronic narrative document (step 222) and saved by the analysis algorithm in the narrative text database 112.

In addition, the corrections drafted by the user may be stored in the suggestion database 117 which is searchable by the analysis algorithm for future use. In one embodiment, the changes made by the user can be converted into suggestions that can be ranked by metadata associated with the suggestion via one or more criteria such as the frequency of use, the user 118 who drafted the correction, or other criteria including but not limited to healthcare provider or facility, department, field of practice, or country. In this way, the analysis algorithm is able to learn and provide more relevant tailored suggestions overtime based on the detected context. In one embodiment, once the suggestions are ranked, if a particular suggestion becomes ranked first it may be incorporated into the initial narrative text document generated in step 202 while the alternatives may be presented in real-time as alternatives in step 214. In another embodiment, the deemed best practice could be retained as the initial electronic narrative document suggested by the system and the highest ranked suggestions could be presented during the modification step 220.

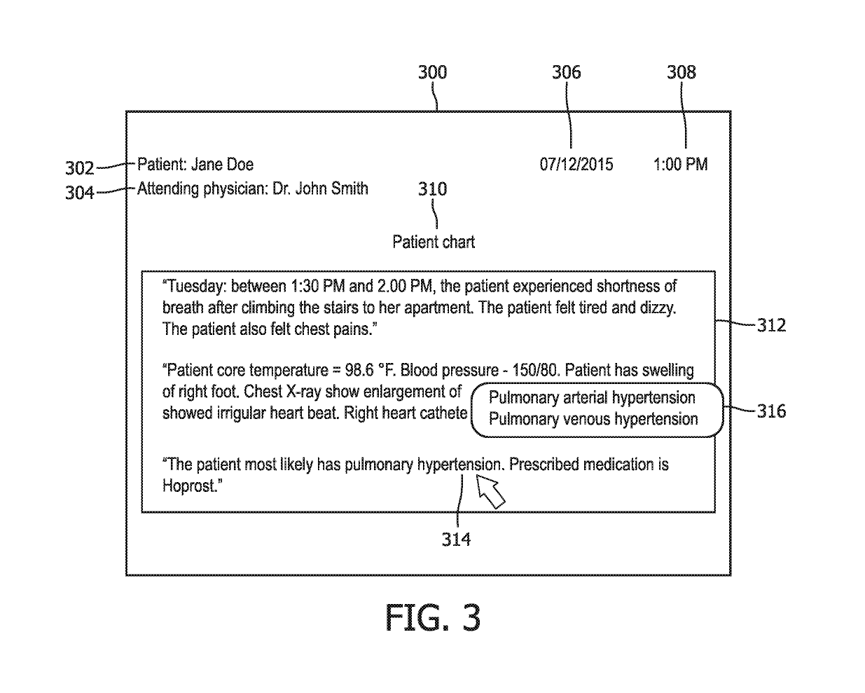

FIG. 3 shows an exemplary electronic narrative document according to an embodiment of the invention. Shown in the document 300 of the exemplary embodiment is the patient chart of a patient named Jane Doe 302 with Dr. John Smith as the attending physician 304. The document includes a timestamp comprising the date 306 and the time 308 of admission. Other types of electronic narrative documents include admission forms, release forms, lab results, physical examination results, treatment plans, and prescriptions. A transcript of the patient symptoms, results of medical tests, initial diagnosis, and prescribed treatment generated by the medical analysis algorithm based on the acquired patient data using one or more devices is shown in field 312. As shown in FIG. 3, the attending physician is trying to modify the patient's initial diagnosis 314 to a more specific diagnosis. When the user positions the cursor over the phrase “Pulmonary Hypertension,” the analysis algorithm interprets that as a signal that the medical personnel is trying to edit that phrase. In response, the analysis algorithm generates a pop-up text box 316 showing suggestions for editing. The suggestions made by the analysis algorithm are based on the patient medical records, as well as on a database of diseases 114. Thereafter, the user chooses the appropriate modification to the patient electronic narrative document 300.

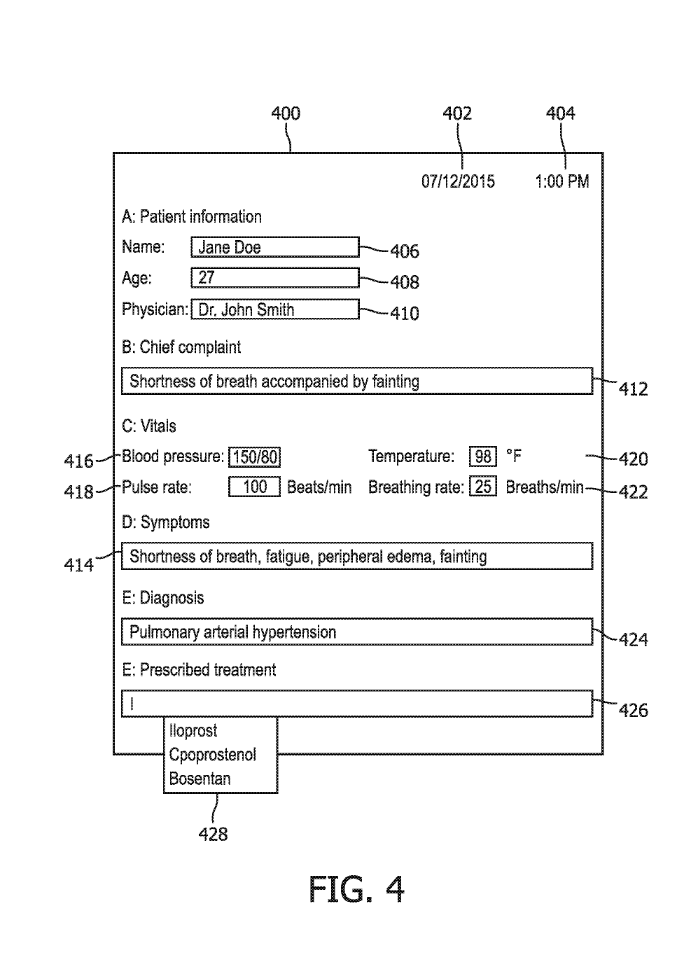

FIG. 4 illustrates another electronic narrative document in the form of a medical record 400 according to the embodiment of the present invention. The medical record 400 comprises a timestamp, patient information, chief complaints, vitals, symptoms, diagnosis and prescribed treatment. The timestamp comprises the date 402 and time 404 indicating the version of the document. The patient information fields, which includes the name 406, age 408 and physician 410, the chief complaint field 412 and the symptoms field 414 display data retrieved from the patient medical records 110. The vitals fields for blood pressure 416, pulse rate 418, temperature 420 and breathing rate 422 display corresponding data retrieved from the medical device 132. The diagnosis field 424 displays an initial diagnosis, which is determined by the medical analysis algorithm using the symptoms from the patient medical records and data from the disease database 114. The user 118 inputs the prescribed medication in the prescribed treatment field 426. As the physician inputs the first few characters, the medical analysis algorithm generates a suggestion box 428 showing the medication suggestions derived from the medicine and treatment database 116.

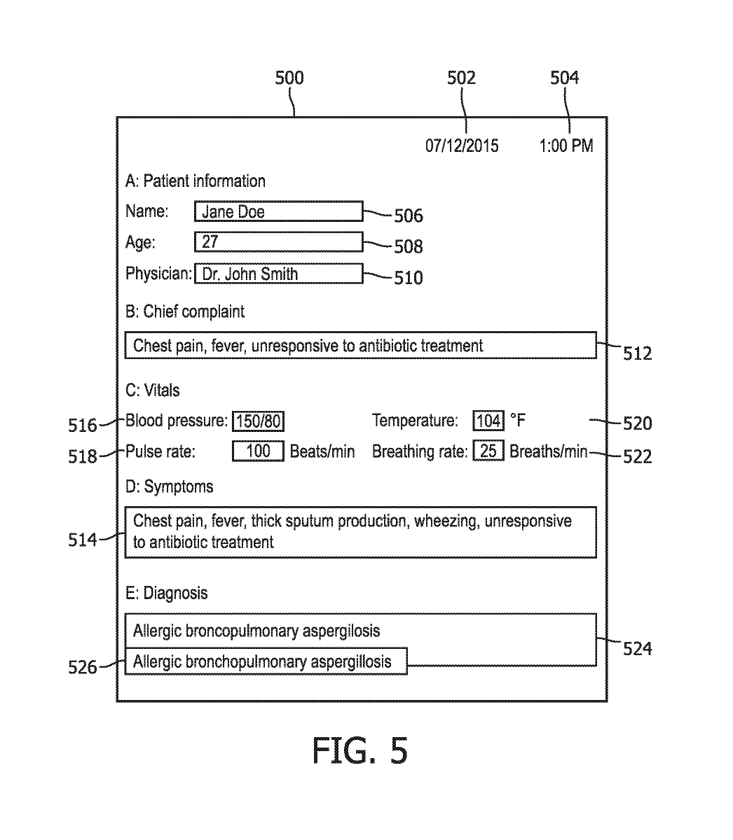

FIG. 5 shows another screenshot 500 of the graphical user interface of a device used by the medical personnel 118. The screenshot 500 is that of an electronic narrative document, which comprises a timestamp, patient information, chief complaint, vitals, symptoms, and diagnosis. The timestamp comprises the date 502 and time 504 that show the most recent creation or modification date and time of the document. The patient information fields (which include the name 506, age 508 and attending physician 510), the chief complaint field 512 and the symptoms field 514 display data retrieved from the patient medical records 110. The vitals fields blood pressure 516, pulse rate 518, temperature 520 and breathing rate 522 display data retrieved from the medical device 132. In this example, the diagnosis entered by the physician in field 524 was misspelled. Thus, the medical analysis algorithm automatically generates a suggestion box 526 showing the appropriate suggested corrections.

In one embodiment, after the user 118 retrieves the patient electronic narrative document using a device, such as a tablet, to review and modify the electronic narrative document, natural language generation provides suggestions for modifications by parsing the text, which includes identifying symbols in either natural or computer language, and the syntax of the sentences or expressions. The meaning of each symbol is defined by identifying each as an event, time, a list of elements, quantity, diagnosis, illness, medication, prescription, or opinion as they are structured in the electronic narrative document. Thereafter, the medical analysis algorithm relates the patterns and statistics derived from the information contained the electronic narrative document to information stored in a hospital main server database. For example, the medical analysis algorithm identifies the patient symptoms from, for example, the patient medical record 110 and searches likely diseases from a compilation of diseases from the disease database 114 corresponding to the patient's symptoms.

The analysis algorithm also preferably generates suggestions for misspelled English word, medical term, diseases, or medicines. In the case of diseases and medicines, the suggested corrections are preferably generated based on information or data stored in the disease database 114 and the medicine and treatment database 116.

In an exemplary embodiment of the present invention, a patient showing symptoms of watery diarrhea, vomiting, stomach pain, nausea, headache, and a fever consults with a physician 118. The disease is initially diagnosed by the physician 118 to be gastroenteritis. A physician uses a medical device 132 to record the symptoms and initial diagnosis in a patient medical record 110 and transmits the record to the main server 100 via a cloud network 122. In one preferred embodiment, the main server 100 runs the medical analysis algorithm to generate an electronic narrative document that includes a summary of the patient's symptoms and vitals along with the initial diagnosis. The physician 118 then retrieves and views the document on a tablet 120. In one embodiment, the user interface 224 immediately displays the words “viral gastroenteritis” and “bacterial gastroenteritis” in a drop-down suggestion box as the cursor hovers over the word “gastroenteritis”. The physician 118 identifies the disease to be viral gastroenteritis due to the watery diarrhea symptom and clicks the word “viral gastroenteritis” in the suggestion box. After the physician 118 selects “viral gastroenteritis,” the phrase automatically replaces “gastroenteritis” in the text. Having completed the editing of the electronic narrative document, the physician 118 then uses the tablet 120 to transmit the modified electronic narrative document to the server 100 via a cloud network 122.

In another embodiment of the present invention, a patient enters an emergency room and is interviewed and examined by a nurse, or other user of the present system, 118. The patient's vital signs are obtained and recorded using one or more medical devices 132. The nurse 118 then retrieves the patient's previously stored medical records from the main server 100 and enters the newly acquired patient information into the retrieved patient's medical record. However, the nurse 118 forgets to include the vital signs information into the patient's medical record. When the user 118 tries to save the updated electronic narrative document, the medical analysis algorithm detects the incomplete data and automatically prompts the user 118 about the missing information. The user 118 then enters the missing information and saves the revised electronic narrative document into the electronic narrative database 112.

In yet another embodiment, a patient consults with a physician, or other such user 118. The user 118 retrieves and reviews the patient's previously stored electronic narrative document, which previously listed “pulmonary hypertension” as the initial diagnosis. Based on the symptoms that the patient is currently experiencing, the user 118 identifies the disease to be a more specific variation, which is pulmonary arterial hypertension. The physician 118 then modifies the diagnosis field of the narrative document. As the user 118 begins to input the prescribed treatment field 426, the algorithm is unable to provide suggestions for the required medication because the disease corresponding to the updated diagnosis is not found in the disease database 114. The user 118 then connects the user device 120, which may be a laptop, to the main server 100 to access the disease database 114 and the medicine and treatment database 116. The physician 118 then edits the disease 114 database to add “pulmonary arterial hypertension” and also edits the medicine and treatment database 216 to add the appropriate medicines, such as iloprost, epoprostenol and bosentan for the disease.

In a further embodiment of the present invention, a patient consults with a physician or other such user 118. The user 118 arrives at an initial diagnosis of dengue fever. Unsure of the physician's initial diagnosis, the physician 118 runs the medical analysis algorithm to confirm the physician's initial diagnosis. The analysis algorithm matches the symptoms with the information contained in the disease database 114 and generates an electronic narrative document that confirms the physician's initial diagnosis. The physician 118 then starts to type in the prescribed treatment field 426, at which point a suggestion box that lists “aspirin” and “paracetamol” appears. The physician 118 then chooses “aspirin,” but the patient happens to have an allergy to aspirin according to the patient's medical record. The analysis algorithm then generates a pop-up notification to notify the physician 118 that the patient is allergic to aspirin. The physician 118 then changes the prescription to “paracetamol.”

In another embodiment, the physician 118 misspells an annotation, for example accidentally writes “three day” instead of either “three times a day” or “for three days.” In this case, the analysis algorithm generates a drop-down box indicating the suggested correct phrases. The physician 118 then selects from the suggested phrases to correct the annotation.

In another embodiment, a patient consults with a physician or other such user 118 in a care facility wherein the patient's electronic narrative document was generated and stored in the database 112. The patient then consults with another physician 118 in a different affiliated hospital regarding a different illness. After being authenticated, the second physician 118 is able to access the first hospital's main server 100 using a user device 120 to retrieve the patient's information or data in the patient medical record 110, as well as the electronic narrative document from the electronic narrative document database 112.

With reference to FIG. 2, the present invention also contemplates a method for automated analysis of medical records. A patient's health-related information or data is acquired from the one or more devices (step 200). Using a medical analysis algorithm (preferably a natural language generation or NLG algorithm), an electronic narrative document about the patient is generated based on the acquired patient health-related information (step 202). The generated electronic narrative document is then stored in the electronic narrative database (step 204). Medical personnel later retrieve the stored electronic narrative document using a user device (step 206) to check for errors (208). If the retrieved electronic narrative document requires no corrections, the retrieved electronic narrative document is stored in the hospital main server and updated or linked to the patient database (110).

If the retrieved electronic narrative document requires corrections, the medical personnel determines the corrections to be made (step 212). Once the corrections are identified, the medical personnel selects or edits the elements to be edited. While the user 118 makes corrections, the analysis algorithm searches the narrative text database and presents suggestions for corrections in real-time (step 214). This may be done via a variety of techniques. One such technique would be for the algorithm to identify the characters typed (which may be complete words, partial-words, phrases or even misspellings). It may suggest a complete word based on the characters typed. It may suggest synonyms based on the characters typed which are deemed to be likely, or often selected, alternatives. It may suggest conceptually similar phrases. Or use any other similar technique known in the art.

Next, the user 118 determines the inputs or corrections to be made (step 216) and compares them with the suggestions provided by the analysis algorithm (step 218). If the user 118 agrees with the one or more suggestions provided by the analysis algorithm, the user 118 selects the matching one or more suggestions which is incorporated into the narrative document and then saves the revised patient electronic narrative document (step 220). If the user 118 does not agree with the one or more suggestions provided by the medical analysis algorithm, the new inputs or corrections made by the user 118 are incorporated in the electronic narrative document (step 222) and saved by the analysis algorithm in the narrative text database 112.

In addition, the corrections drafted by the user may be stored in the suggestion database 117 which is searchable by the analysis algorithm for future use. In one embodiment, the changes made by the user can be converted into suggestions that can be ranked by metadata associated with the suggestion via one or more criteria such as the frequency of use, the user 118 who drafted the correction, or other criteria including but not limited to healthcare provider or facility, department, field of practice, or country. In this way, the analysis algorithm is able to learn and provide more relevant tailored suggestions overtime based on the detected context. In one embodiment, once the suggestions are ranked, if a particular suggestion becomes ranked first it may be incorporated into the initial narrative text document generated in step 202 while the alternatives may be presented in real-time as alternatives in step 214. In another embodiment, the deemed best practice could be retained as the initial electronic narrative document suggested by the system and the highest ranked suggestions could be presented during the modification step 220. The modification step 220 may be performed using one or any combinations of manual typing, gesture-driven recognition, and voice recognition. After being presented with the suggested corrections (step 218), the medical personnel may choose to accept or override one or more of the suggested corrections (step 218).

The present invention is not intended to be restricted to the several exemplary embodiments of the invention described above. Other variations that may be envisioned by those skilled in the art are intended to fall within the disclosure. For instance, while this invention is preferably employed in a networked environment with separate medical device(s) 132, user device(s) 120 and server (100) connected via a network. It is also possible that the unique features of this invention could be housed in a single device such as the medical device 132, user device 120, or server.

What is claimed is:

1. A system for automated analysis of medical records comprising:
a server for executing an analysis algorithm for generating an electronic narrative document, wherein the analysis algorithm predicts and suggests input when editing the electronic narrative document based on a patient's medical records; and
a user device for modifying the generated electronic narrative document.

2. A system as recited in claim 1, wherein the electronic narrative document is generated based on querying at least one of a patient medical records database, a disease database, or a medication treatment database.

3. A system as recited in claim 1, wherein the analysis algorithm uses natural language processing to generate the narrative text document.

4. A system as recited in claim 1, wherein the analysis algorithm uses natural language processing to predict and suggest input.

5. A system as recited in claim 4, wherein the system ranks the suggestions for subsequent use.

6. A system as recited in claim 5, wherein the system ranks the suggestions based on frequency of use, and wherein the highest ranked suggestion is incorporated into subsequent narrative text documents, and wherein lower ranked suggestions may be suggested as alternatives.

7. A method for automated analysis of medical records comprising:
executing a medical analysis algorithm to analyze the medical records and to generate an electronic narrative document;
storing the generated electronic narrative document in the patient database;
retrieving and viewing the stored electronic narrative document;
modifying the retrieved electronic narrative document, wherein the medical analysis algorithm predicts and suggests input during the modification step based on the patient's medical records; and
storing the electronic narrative document in the patient database.

8. A method as recited in claim 7, wherein the electronic narrative document is generated based on querying at least one of a patient medical records database, a disease database, or a medication treatment database.

9. A method as recited in claim 7, wherein the analysis algorithm uses natural language processing to generate the narrative text document.

10. A method as recited in claim 7, wherein the analysis algorithm uses natural language processing to predict and suggest input.

11. A method as recited in claim 10, wherein method further includes querying the stored suggestions for subsequent use.

12. A method as recited in claim 11, wherein the system ranks the suggestions based on frequency of use, and wherein the highest ranked suggestion is incorporated into subsequent narrative text documents, and wherein lower ranked suggestions may be suggested as alternatives.
